(19) United States
(12) Patent Application Publication
(10) Pub. No.: US 2025/0150546 A1
(43) Pub. Date: May 8, 2025

(54) IMAGE PROCESSING APPARATUS, CONTROL METHOD THEREOF, AND STORAGE MEDIUM

(71) Applicant: CANON KABUSHIKI KAISHA, Tokyo (JP)

(72) Inventor: SHOEI MORIBE, Kanagawa (JP)

(21) Appl. No.: 18/929,232

(22) Filed: Oct. 28, 2024

(30) Foreign Application Priority Data
Nov. 8, 2023 (JP) 2023-190638

(51) Int. Cl. H04N 1/401; B41J 2/21; G06T 7/73; H04N 1/03; H04N 1/60

(52) U.S. Cl. CPC H04N 1/401; B41J 2/2135; G06T 7/73; H04N 1/03; H04N 1/6044; G06T 2207/10024; G06T 2207/30204

(57) ABSTRACT

The image processing apparatus according to the present disclosure has: a printing unit configured to print a chart image including a patch extending in a main scanning direction intersecting a conveyance direction of a sheet and having a uniform density and a marker for identifying a position in the main scanning direction; a scanning unit configured to read the chart image printed by the printing unit; and a correction unit configured to correct reading characteristics of the scanning unit based on reading results read by the scanning unit, wherein the marker is arranged in the main scanning direction based on information relating to unevenness in the main scanning direction of the printing unit or the scanning unit.

### BACKGROUND

### Field

The present disclosure relates to a color adjustment technique of a printer.

### Description of the Related Art

As an image forming apparatus for forming an arbitrary image on the surface of paper, an ink jet (IJ) printer is used widely, which forms an image by ejecting ink droplets from a plurality of nozzles. It is difficult to completely prevent the ink landing position and ejection amount from deviating from the target position and ejection amount in all the nozzles arranged side by side in the print head and there is a case where belt-shaped or streak-shaped density unevenness (banding) appears on a printed material. Consequently, color adjustment (called “head shading correction”) to correct printing-target image data is performed in accordance with the printing characteristics of each nozzle (or each module), such as the shift of the ink ejection amount and the landing position, so that the density unevenness does not occur. In the head shading correction, the printing characteristics of the print head are obtained by scanning a test chart, but in a case where there are variations of the sensor reading characteristics, the variations of the sensor reading characteristics are taken in as the printing characteristics. In this case, on the contrary, the head shading correction causes the density unevenness to occur. Consequently, prior to the scan of a test chart, calibration of illumination and sensors is performed generally with reference to a white reflection standard provided internally or externally. However, resulting from the angle dependence of the sensors and illumination, the sheet surface characteristics and the like, particularly in a case where the intensity and the spectral characteristics of gray, chromatic color or the like are different from those of the white reflection standard, there is a possibility that the variations of the sensor reading characteristics still remain. In this regard, Japanese Patent Laid-Open No. 2019-220828 has described a technique to suppress density unevenness resulting from the sensor reading characteristics by correcting the scanned data of a plurality of patch images of a plurality of tones based on the colorimetric data of a uniform patch image of each color of CMYK. Further, Japanese Patent Laid-Open No. 2014-168933 has disclosed a technique to insert a marker into a patch, which causes the position on the colorimetric data for determining the colorimetry position on the colorimetric data and the position on the image data to correspond to each other.

### SUMMARY

However, there is a case where it is still difficult to obtain a colorimetric value stably even by the above-described technique. For example, in a case where the print head includes a plurality of chip modules, on a condition that the marker position and the chip module boundary do not coincide with each other, a step in density occurs and it may happen sometimes that an accurate colorimetric value cannot be obtained. Further, in a case where the interval between markers and the sensor unevenness period do not coincide with each other, an error occurs in the reading value of the sensor within the patch, and therefore, it may happen sometimes that an accurate colorimetric value cannot be obtained.

Further features of the present disclosure will become apparent from the following description of exemplary embodiments with reference to the attached drawings.

The image processing apparatus according to the present disclosure includes: a printing unit configured to print a chart image including a patch extending in a main scanning direction intersecting a conveyance direction of a sheet and having a uniform density and a marker for identifying a position in the main scanning direction; a scanning unit configured to read the chart image printed by the printing unit; and a correction unit configured to correct reading characteristics of the scanning unit based on reading results read by the scanning unit, wherein the marker is arranged in the main scanning direction based on information relating to unevenness in the main scanning direction of the printing unit or the scanning unit.

Further features of various embodiments will become apparent from the following description of exemplary embodiments with reference to the attached drawings.

### BRIEF DESCRIPTION OF THE DRAWINGS

FIG. 1 is a diagram showing a hardware configuration of an ink jet printer;

FIG. 2A is a diagram showing a configuration example around a printing unit, FIG. 2B is an enlarged diagram of a print head, and FIG. 2C is an enlarged diagram of a chip module;

FIG. 3 is a diagram showing an internal configuration of an image processing unit;

FIG. 4 is a diagram showing one example of a color adjustment table;

FIG. 5 is a diagram showing one example of a scan correction table;

FIG. 6 is a flowchart showing a flow of processing in the image processing unit;

FIG. 7 is a flowchart showing a flow of color adjustment table generation processing;

FIG. 8 is a diagram showing one example of an HS chart;

FIG. 9A is a diagram showing one example of a measured curve and FIG. 9B is a diagram explaining a calculation process of a correction amount;

FIG. 10 is a flowchart showing a flow of generation processing of a scan correction table;

FIG. 11A and FIG. 11B are each a diagram showing one example of an SS chart image of a first embodiment;

FIG. 12 is a diagram explaining a calculation process of a correction amount;

FIG. 13 is a flowchart showing a flow of creation processing of an SS chart image;

FIG. 14A is a diagram showing one example of an SS chart image of the first embodiment and FIG. 14B is a diagram showing one example of a conventional SS chart image;

FIG. 15 is a diagram showing one example of an SS chart image according to a modification example 2 of the first embodiment;

FIG. 16A and FIG. 16B are each a diagram explaining effects of a second embodiment;

FIG. 17 is a diagram showing one example of an SS chart image of a third embodiment; and

FIG. 18 is a diagram showing one example of an SS chart image according to a modification example 1 of the third embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

### <Hardware Configuration of Image Forming Apparatus>

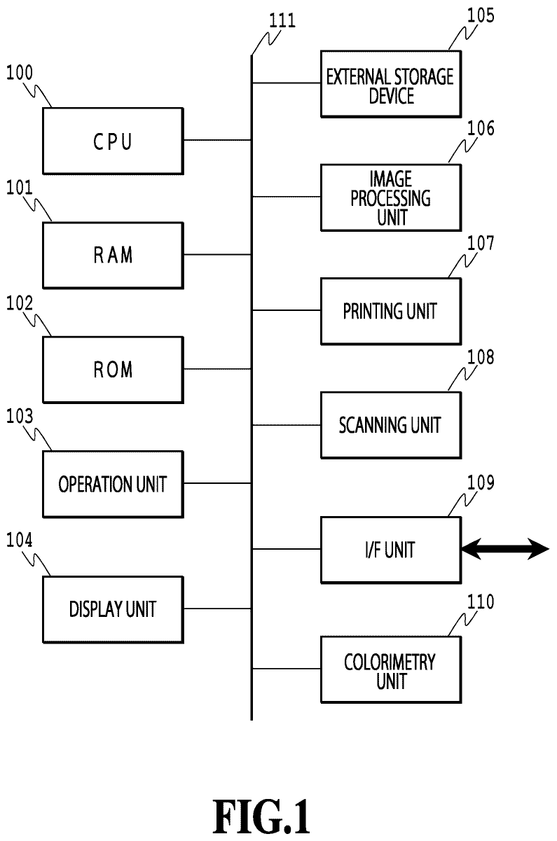

FIG. 1 is a diagram showing a hardware configuration of an ink jet printer as an image forming apparatus according to the present embodiment. The image forming apparatus in the present embodiment comprises a CPU 100, a RAM 101, a ROM 102, an operation unit 103, a display unit 104, an external storage device 105, an image processing unit 106, a printing unit 107, a scanning unit 108, an I/F unit 109, a colorimetry unit 110, and a bus 111. The CPU 100 controls the operation of the entire image forming apparatus by loading input data and computer programs stored in the ROM 102 and the external storage device, to be described later, onto the RAM 101 and executing them. For example, the CPU 100 generates image data in the bitmap format of each page by interpreting PDL data included in an input print job. Here, a case where the CPU 100 controls the entire image forming apparatus is explained as one example thereof, but it may also be possible to control the entire image forming apparatus by a plurality of pieces of hardware sharing processing. The RAM 101 temporarily stores computer programs and data read from the external storage device 105 and data received from the outside via the I/F unit 109. Further, the RAM 101 is used as a storage area in a case where the CPU 100 performs arithmetic processing and as a storage area in a case where the image processing unit 106 performs image processing. The ROM 102 stores setting parameters used to set each unit in the image forming apparatus, boot programs and the like. The operation unit 103 is an input device, such as a keyboard and a mouse, and receives operations (instructions) by an operator. Due to this, it is possible for the operator to input various instructions to the CPU 100. The display unit 104 is a display device, such as a CRT and a liquid crystal screen, and displays processing results by the CPU 100 in images, characters and the like. In a case where the display unit 104 is a touch panel capable of detecting a touch operation, it may also be possible for the display unit 104 to function as part of the operation unit 103. The external storage device 105 is a large-capacity storage device, typically such as a hard disk drive. In the external storage device 105, computer programs, data and the like for causing the OS and the CPU 100 to perform various pieces of processing are stored. Further, in the external storage device 105, temporary data (for example, image data that is input and output, threshold value matrices used by the image processing unit 106 and the like) that is generated by the processing of each unit is also stored. The computer programs and data stored in the external storage device 105 are read appropriately in accordance with the control by the CPU 100 and loaded onto the RAM 101 to be taken as the target of the processing by the CPU 100. The image processing unit 106 is implemented as a processor or a dedicated image processing circuit capable of executing computer programs and performs various pieces of image processing for converting image data that is input as a printing target into image data that can be output by the printing unit 107. It may also be possible to adopt a configuration in which the CPU 100 performs various pieces of image processing as the image processing unit 106, in place of preparing a dedicated processor as the image processing unit 106. The printing unit 107 forms an image on a sheet as a printing medium by using ink as a color material based on image data received directly from the image processing unit 106 or via the RAM 101 or the external storage device 105. Details of the printing unit 107 will be described later. The scanning unit 108 is an image sensor (line sensor or area sensor) for optically reading an image formed on a sheet by the printing unit 107. Details of the scanning unit 108 will be described later. The I/F unit 109 functions as an interface for connecting the image forming apparatus and an external device. Further, the I/F unit 109 also functions as an interface for performing transmission and reception of data with a communication device by using infrared communication, wireless LAN (Local Area Network) or the like, for connecting to the internet, and so on. Due to this, the I/F unit 109 receives printing-target image data from, for example, an external PC (not shown schematically). The colorimetry unit 110 is a colorimeter for measuring the color of an image formed on a sheet by the printing unit 107. Details of the colorimetry unit 110 will be described later. Each of the above-described units is connected to the bus 111 and capable of performing transmission and reception of data via the bus 111.

The hardware configuration shown in FIG. 1 is one example and the image forming apparatus may have a hardware configuration whose contents are different from those shown in FIG. 1. For example, a configuration may be acceptable in which the printing unit 107 is connected via the I/F unit 109. Further, it may also be possible to adopt a configuration in which colorimetric information is obtained from an external colorimeter via the I/F unit 109, in place of the configuration in which the colorimetry unit 110 is comprised as part of the image forming apparatus.

### (Details of Printing Unit)

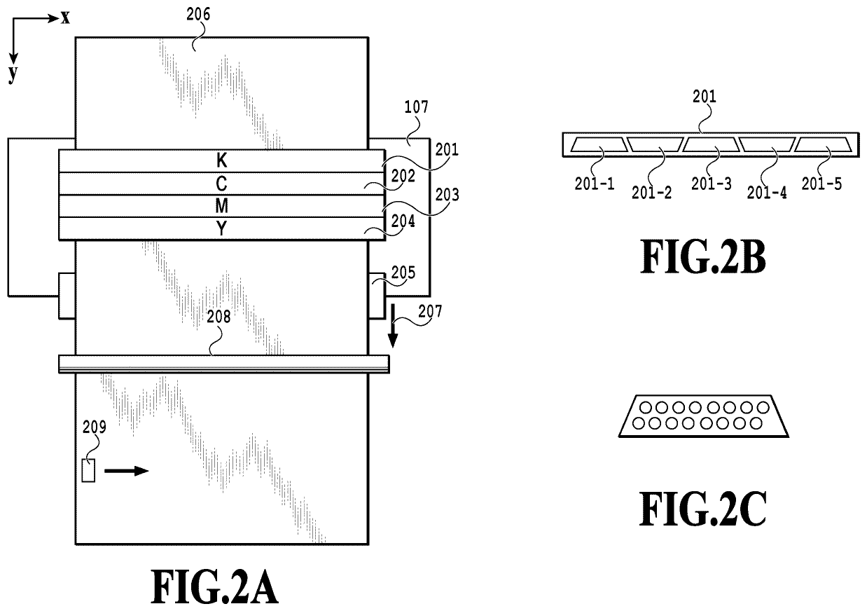

The printing unit 107 comprises, as shown in FIG. 2A, print heads 201 to 204 corresponding to black (K), cyan (C), magenta (M), and yellow (Y), respectively. Each of the print heads 201 to 204 is a so-called full-line type and in which a plurality of nozzles for ejecting ink is arrayed along a predetermined direction in a range corresponding to the full width of a sheet 206. FIG. 2B is an enlarged diagram of the black print head 201 and shows that the print head 201 further includes a plurality of chip modules 201-1 to 201-5. FIG. 2C is an enlarged diagram of the chip module 201-1 and in which 16 nozzles exist. In the present embodiment, explanation is given on the assumption that the resolution of the arrangement of nozzles in the print heads 201 to 204 of each of CMYK is 1,200 dpi.

The sheet 206 as a printing medium is conveyed in one direction indicated by an arrow 207 in FIG. 2A by a conveyance roller 205 (and another roller, not shown schematically) rotating by the driving force of a motor (not shown schematically). Then, while the sheet 206 is being conveyed, an image of one raster corresponding to the nozzle row of each of the print heads is formed sequentially by ink being ejected from a plurality of nozzles of each of the print heads 201 to 204 in accordance with print image data. By repeating the operation to eject ink from each of the print heads 201 to 204 for the sheet 206 that is conveyed as described above, for example, it is possible to form an image corresponding to one page on the sheet.

### (Details of Scanning Unit and Colorimetry Unit)

The scanning unit 108 optically reads the sheet 206 that is conveyed and stores in the external storage device 105 as read image data (scanned data). As shown in FIG. 2A, the scanning unit 108 has a line sensor 208 covering the full width of the sheet 206. The line sensor 208 sequentially captures the sheet 206 that is conveyed and stores in the external storage device 105 as two-dimensional image data including RGB information and luminance information. In this case, the resolution of the image data is, for example, 600 dpi both in the x-direction and in the y-direction in FIG. 2A. Alternatively, the resolution in the x-direction may be different from the resolution in the y-direction, such as that the resolution in the x-direction is 1,200 dpi and the resolution in the y-direction is 600 dpi. It may also be possible to design a configuration in which the full width of the sheet 206 is covered by overlapping two line sensors. Alternatively, such a configuration may also be accepted in which the full width of the sheet 206 is covered by, for example, sliding one line sensor.

The colorimetry unit 110 measures the color at a predetermined y-position of the sheet 206 that is conveyed with a colorimeter 206 arranged on the downstream side of the line sensor 208 while performing a scan in the x-direction and stores the measurement results in the external storage device 105 as spectral reflectance data. Alternatively, the colorimetry unit 110 stores the color value in a device-independent color space, which is calculated from the spectral reflectance data, in the external storage device 105. Specifically, the colorimetry unit 110 stores spectral reflectance data at intervals of 10 nm from 380 to 780 nm, which is a visible light range, and the spectral reflectance data after being converted into data in a color space, such as CIE XYZ, CIE Lab, sRGB, or AdobeRGB. Here, while the colorimeter 209 performs a scan in the sensor direction, the conveyance of the sheet 206 (paper feed in the y-direction) is stopped. That is, after the scan and colorimetry for a certain measurement area are completed, the sheet 260 is conveyed by a predetermined amount and the scan and colorimetry for another measurement area are performed. By repeating the conveyance of the sheet 260 and the scan and colorimetry by the colorimeter 209 as above, the colorimetric value corresponding to each measurement area is obtained. In this case, in order to avoid the sheet conveyance control and the apparatus configuration from becoming complicated, it is also possible to perform colorimetry by evacuating the sheet 206 to a conveyance path different from the conveyance path for printing and image capturing. Alternatively, such a configuration may also be possible in which the colorimeter is prepared separately outside the image forming apparatus and colorimetry is performed for the sheet 206 by the colorimeter, and then, the obtained colorimetric data is input via the I/F unit 109. The time interval of colorimetry by the colorimetry unit 110 is generally longer than the interval of reading (interval of scanning) of the scanning unit 108 and for example, the interval of colorimetry in the y-direction is five times/inch. Further, the spectral reflectance data, which is colorimetry results, is obtained as the reflectance averaged within the opening shape of the colorimeter 209, for example, within a circle with a diameter q of 3.5 mm.

Each of the line sensor 208 of the scanning unit 108 and the colorimeter 209 of the colorimetry unit 110 is only required to be located on the downstream side of the printing unit 107 and for example, such a configuration in which the colorimeter 209 is installed on the upstream side of the line sensor 208 may be possible.

### (Details of Image Processing Unit)

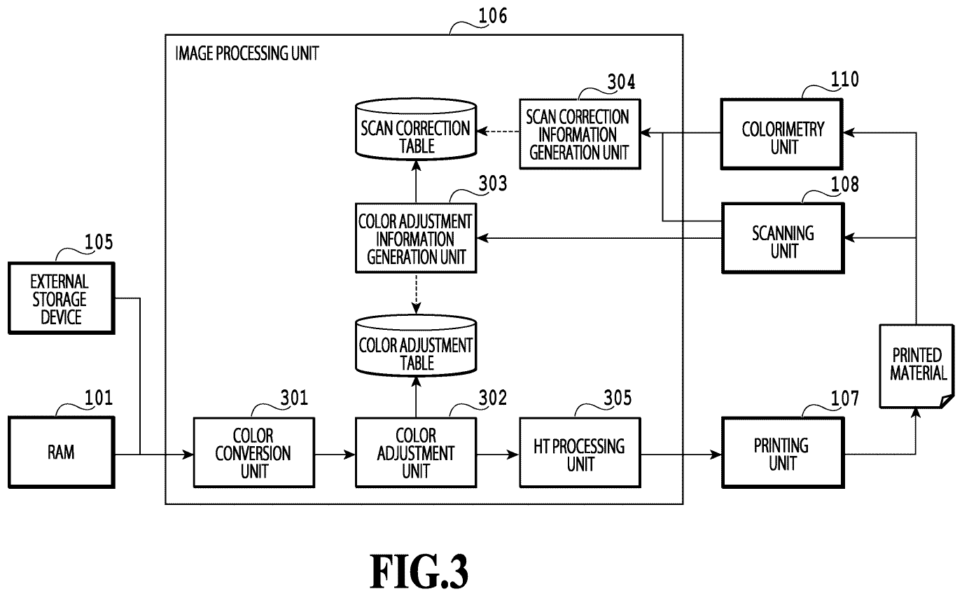

FIG. 3 is a diagram showing the internal configuration of the image processing unit 106. In the following, with reference to FIG. 3, the function of the image processing unit 106 is explained in detail. The image processing unit 106 has a color conversion unit 301, a color adjustment unit 302, and a halftone processing unit (in the following, described as “HT processing unit”) 305. Further, the image processing unit 106 has a color adjustment information generation unit 303 and a scan correction information generation unit 304.

The color conversion unit 301 converts input image data into image data in accordance with the ink colors that are used in the printing unit 107. For this conversion, it is possible to use a publicly known method, for example, such as matrix arithmetic processing and processing using a three-dimensional LUT (lookup table). The input image data has 8-bit coordinate values (R, G, B) in a color space, such as sRGB, which are, for example, representation colors of a monitor, and the color-converted image data has an 8-bit color signal value of each of CMYK in accordance with the printing unit 107. That is, by the color conversion processing, RGB data is converted into CMYK data. The CMYK data represents an amount of ink to be used (ejection amount) of each ink that is ejected onto the surface of paper in order for the printing unit 107 to represent an image. The input image data is not limited to RGB data and may be CMYK data. Even in a case where CMYK data is input from the beginning, it is preferable to perform conversion processing using a four-dimensional LUT that converts input CMYK data into C′M′Y′K′ data for limiting the total amount of ink and for color management.

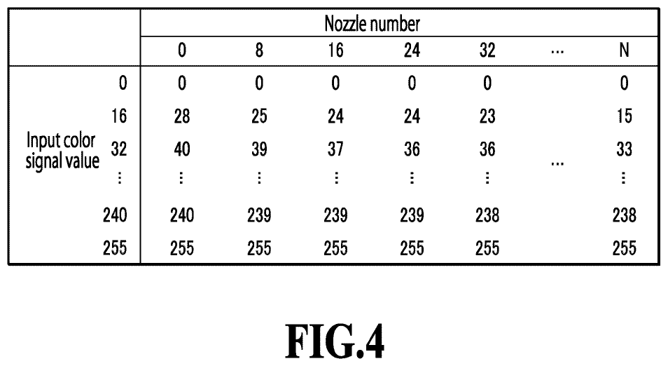

The color adjustment unit 302 refers to the color adjustment table generated by the color adjustment information generation unit 303 and performs color adjustment processing that takes into consideration the ink ejection unevenness of each of the print heads 201 to 204 for the color-converted CMYK data. This color adjustment processing is also called head shading correction processing and in the present embodiment, in order to correct the density unevenness of a printed material, which results from the unevenness in the printing characteristic of the print heads 201 to 204, correction is performed for each nozzle by using the color adjustment table (HS correction table) of each color of CMYK prepared in advance. FIG. 4 shows one example of the color adjustment table. In the color adjustment table shown in FIG. 4, the adjusted color signal value (output color signal value) corresponding to each input color signal value (0, 16, 32, . . . , 240, 255) is stored in association with the nozzle number. For example, in a case where the input color signal value of the pixel corresponding to the nozzle number “16” of the CMYK data is “32”, the adjusted color signal value of the pixel will be “37” by the color adjustment processing. In the color adjustment table shown in FIG. 4, an input color signal value that is not predefined is calculated by specifying input color signal values in the vicinity from among the predefined input color signal values and using interpolation processing from the output color signal values thereof. For example, in a case where the input color signal value of the pixel corresponding to the nozzle number “0” is “8”, by the linear interpolation of the output color signal value “0” in a case where the input color signal value is “0” and the output color signal value “28” in a case where the input color signal value is “16”, “14” is obtained as the output color signal value thereof. Of course, it may also be possible to store the output color signal values for all the input color signal values without using the interpolation processing. It is also possible to perform the color adjustment processing by function transformation or matrix transformation in place of the table method.

The color adjustment information generation unit 303 receives scanned data of a chart (in the following, called “HS chart”) for generating a color adjustment table from the scanning unit 108 and generates the above-described color adjustment table. Details of the color adjustment table generation processing will be described later.

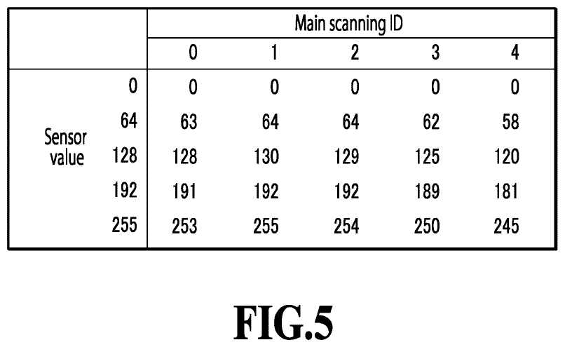

The scan correction information generation unit 304 generates a table (scan correction table) that is referred to in sensor shading correction processing for correcting the unevenness in the sensor reading characteristics. For this generation, the scanned data of the HS chart received from the scanning unit 108 and the colorimetric data of a chart (in the following, called “SS chart”) for generating the scan correction table, which is received from the colorimetry unit 110, are used. FIG. 5 shows one example of the scan correction table. In FIG. 5, the value after being corrected corresponding to the sensor reading value (in the following, described as “sensor value”) is stored in association with the identification number (main scanning ID: 0 to 4) corresponding to the reading position in the x-direction (main scanning direction) in the scanned data. For example, in a case where the sensor value at the reading position at which the main scanning ID is “0” is “64”, the sensor value (SS correction value) for which the sensor shading correction processing has been performed will be “63”. A sensor value that is not predefined in the scan correction table shown in FIG. 5 is calculated by interpolation processing using SS correction values corresponding to the sensor values adjacent in the predefined sensor values. Similarly, a sensor value at the pixel position that does not exist in the scan correction table is also calculated by the interpolation processing using SS correction values corresponding to the sensor values adjacent in the predefined sensor values. Of course, it is also possible to store the SS correction values corresponding to all the sensor values and each reading position without using the interpolation processing. As in the case of the color adjustment table, in the scan correction table, it is also possible to perform the sensor shading correction processing by function transformation or matrix transformation in place of the table method. Details of SS correction table generation processing will be described later.

The HT processing unit 305 performs halftone processing for each color plane for the color-adjusted CMYK data and generates halftone image data (in the following, described as “HT image data”) represented by halftone dots that the printing unit 107 can represent. By this halftone processing, binary HT image data in which each pixel has the value of “0” or “1” is generated for each color plane of CMYK. For the halftone processing, it may be possible to apply a publicly known method, such as the dither method and the error diffusion method.

The number of tones of the HS chart and the SS chart is arbitrary and it is possible to increase or decrease the number of tones in accordance with the required accuracy and the sheet size. Similarly, it is also possible to arbitrarily change the size and format of the color adjustment table and the scan correction table.

### (Processing Flow of Image Processing Unit)

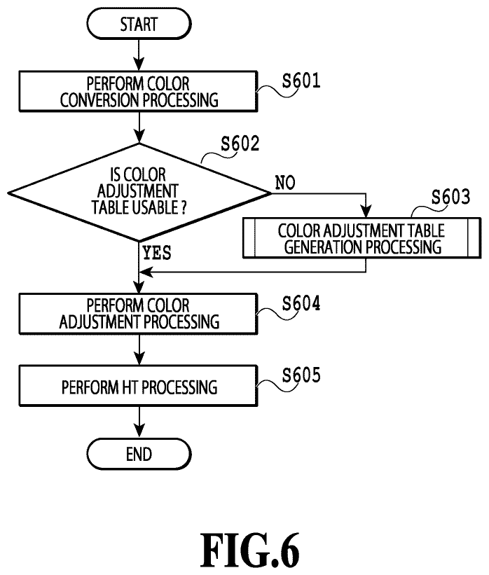

Next, each piece of processing that is performed by the image processing unit 106 is explained along the flowchart shown in FIG. 6. In a case where a user inputs a print job to the image forming apparatus through the operation unit 103, printing-target image data (bitmap image of each page) and printing conditions are loaded onto the RAM 101. Then, the series of processing shown in the flowchart in FIG. 6 is started and performed for each page. Here, the print job is information on instructions for print processing and includes, in addition to PDL data predefining contents to be printed for each page, information on the number of copies and the printing sheet, information on the print mode, and printing conditions, such as single-sided printing/double-sided printing, Nin1 and the like. In the information on the sheet, the maker name, the model number and the like are included, in addition to the sheet type, such as plain paper and glossy paper, and the sheet size, such as A4 and A3. Further, in the information on the print mode, the designation of a high coloring mode in which the conveyance speed is reduced and the amount of ink is increased and an ink-saving mode in which the conveyance speed is increased and the amount of ink is reduced is included. In the following explanation, a symbol “S” means a step.

At S601, the color conversion unit 301 converts RGB data, which is input image data, into CMYK data by performing color conversion processing for the RGB data.

At next S602, the color adjustment unit 302 determines whether or not a color adjustment table in conformity with the printing conditions designated in the print job can be used. Specifically, in a case where there exists a color adjustment table in the external storage device 105 or the like, which corresponds to the maker name, the model number, and the sheet type of the designated sheet, or the contents of the designated print mode, the color adjustment unit 302 determines that it is possible to use a color adjustment table in conformity with the printing conditions. On the other hand, in a case where a color adjustment table whose maker name, the model number and the like match the maker name, the model number and the like of the designated sheet does not exist in the external storage device 105 or the like, the color adjustment unit 302 determines that there is not a color adjustment table that can be used. The reason is that the correction amount for correcting the nozzle characteristics is supposed to be not in conformity with the designated sheet. Consequently, in a case where there is no concern that the correction amount for correcting the nozzle characteristics is not in conformity therewith, it may also be possible to determine that the color adjustment table can be used even though part of the printing conditions do not match. For example, the sheet basis weight and the sheet size do not affect the correction amount so much, and therefore, it is possible to determine that the color adjustment table in conformity with the printing conditions is in the usable state even though the basis weight and the size are different from those of the sheet at the time of the generation of the stored color adjustment table. In a case where a new type of sheet is set, whose paper quality is different from that of the sheet at the time of the generation of the stored color adjustment table, it is preferable to derive the correction amount for head shading correction by using the newly set sheet. Further, it may also be possible to take into consideration the elapsed time from the generation and whether or not the head cleaning processing has been performed. That is, in a case where the color adjustment table in accordance with the designated sheet is already generated and stored and a predetermined time has elapsed from the generation, it may also be possible to determine that there is not a color adjustment table that can be used. Alternatively, in a case where the head cleaning processing has been performed after the generation, it may also be possible to determine that there is not a color adjustment table that can be used. Further, it may also be possible for a user to determine whether or not the table can be used and store flag information indicating the results of the determination in advance and perform determination based on the flag information. In that case, it is sufficient for a user to set a flag through the operation unit 103 at timing at which a new sheet is set or the head is replaced with another. Alternatively, it may also be possible to set a flag by checking the results of test printing by visual inspection. In a case where the determination results indicate that a color adjustment table that can be used exists in the external storage device 105 or the like, the processing advances to S604. On the other hand, in a case where it is determined that there is not a color adjustment table that can be used, the processing advances to S603.

At S603, the color adjustment information generation unit 303 generates a color adjustment table in conformity with the printing conditions designated in the print job. Details of the color adjustment table generation processing will be described later.

At S604, the color adjustment unit 302 performs color adjustment processing for the CMYK data obtained by the color conversion at S601 by using the color adjustment table that is in conformity therewith and can be used. Here, it is assumed that the density of an image that is formed by the head module 201 in a case where the input color signal value is “32” is relatively high compared to the target density or the density that is formed by another print head. In this case, by changing the pixel value of the input image data to a smaller value (for example, “28”), it is possible to reduce the probability that dots are formed by the head module 201 in a case where the input color signal value is “32”. By the processing such as this, it is possible to reduce the difference from the target density and another print head. In the present embodiment, the color adjustment table as shown in FIG. 4 described previously is generated and stored in advance for each of a variety of types of sheet and for each print mode. Then, in a case where there is not a color adjustment table in accordance with the sheet and the print mode designated in the print job, a color adjustment table is generated newly. In this manner, the change in density that occurs in each print head and each print nozzle is suppressed.

At S605, the HT processing unit 305 performs halftone processing for the color-adjusted CMYK data. The generated HT image data is sent to the printing unit 107 and in the printing unit 107, print processing is performed based on the HT image data.

The above is the contents of the processing in the image processing unit 106. The processing such as this is performed each time a print job is input and it is possible to print the designated number of sheets of the image designated by a user. In the determination at S602, in a case where the model number and the maker name of the sheet are different, but the sheet type is the same, it may also be possible to determine that the color adjustment table can be used. For example, such a case is where even though the coated paper is designated, the coated paper of the same maker has run out, and therefore, replenishment is performed with the coated paper of another maker. In the case such as this, on a condition that it is known empirically that there is no problem, it may also be possible to enable the application of the color adjustment table used before the replenishment as it is.

### <Generation Processing of Color Adjustment Table>

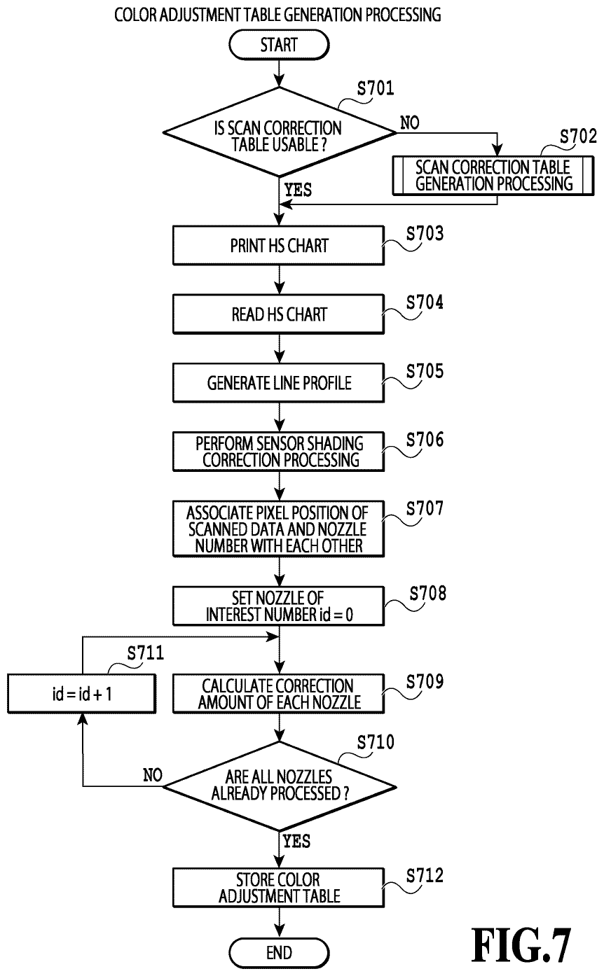

Following the above, with reference to the flowchart in FIG. 7, the generation processing of a color adjustment table at S603 described above is explained in detail. This processing is performed for each ink color.

First, at S701, whether or not a scan correction table in conformity with the printing conditions designated in the print job can be used is determined. The reference at the time of this determination may be the same as the reference shown at S602 in the flowchart in FIG. 6 described previously. The reason is that as in the case of the color adjustment table, for the scan correction table also, the correction amount for correcting the sensor reading characteristics may be different depending on the sheet to be used and the print mode. Consequently, in a case where a new type of sheet is used, it is preferable to derive in advance a correction amount for sensor shading correction processing with the new type of sheet. However, the spectral characteristics are hardly affected by the sheet basis weight and the sheet size, and therefore, it may also be possible to permit these differences and perform determination by using a bit less strict reference. It may also be possible to take into consideration the elapsed time from the generation and this is the same as at S602 described previously. That is, only in a case where there is a scan correction table whose elapsed time from its generation is within a predetermined time, it may be possible to determine that there is a scan correction table that can be used. The reason is that there is a case where the color of the filter inside the sensor changes or the spectral characteristics of the illumination change as time elapses and there is a possibility that the scan correction table is no longer suitable to the sensor having changed such as this. In a case where the results of the determination indicate that there is a scan correction table that can be used, the processing advances to S703. On the other hand, in a case where there is not a scan correction table that can be used, the processing advances to S702 and processing to newly generate a scan correction table is performed. Details of scan correction table generation processing at S702 will be described later.

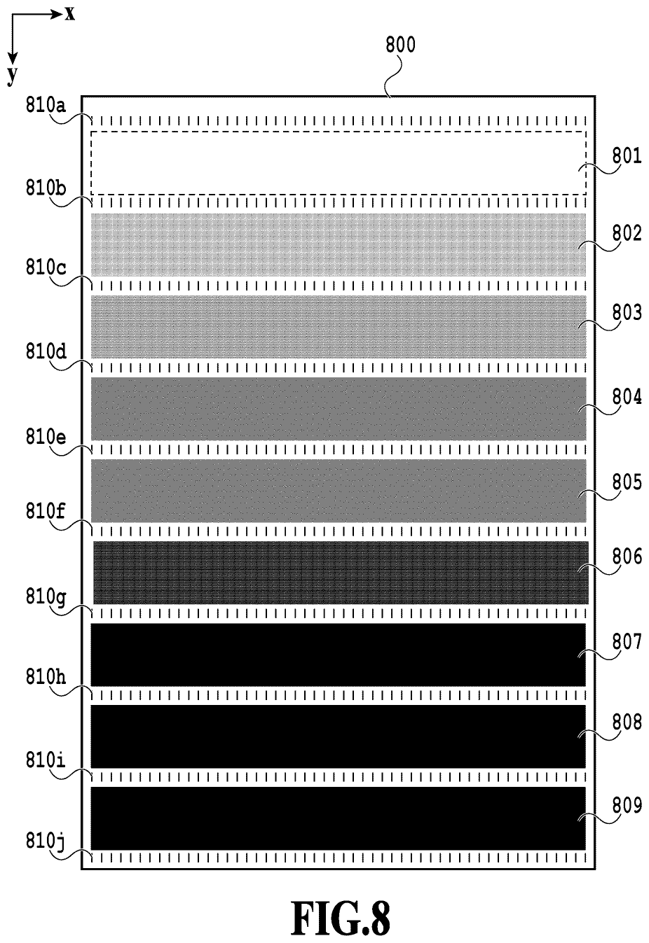

At S703, the HS chart is printed and output. Specifically, the image data of the HS chart stored in the external storage device 105 or the ROM 102 is read, the HT processing unit 305 performs halftone processing, and the printing unit 107 performs print processing by using the generated HT image data. FIG. 8 shows one example of the HS chart. In the HS chart, a pattern area for adjusting the nozzle position to the reading position exists, in addition to the measurement area for obtaining the density characteristics of each nozzle. In a case of an HS chart 800 in FIG. 8, nine patches (measurement areas) 801 to 809 exist, whose tones are different from one another, and each patch has the shape of a horizontally elongated rectangle extending in the main scanning direction substantially perpendicular to the conveyance direction of the sheet and having a uniform density. In addition, position adjustment patterns 810a to 810j are arranged outside the patch so as to sandwich each of the measurement areas 801 to 809. A position adjustment pattern 810 is generally called “ruler” and includes a plurality of thin lines formed at predetermined intervals in the y-direction (each thin line has a predetermined length in the y-direction and generally also called “marker”). The main scanning direction of each patch is not necessarily required to be perpendicular to the conveyance direction but only required to simply intersect the conveyance direction provided that at least part thereof is perpendicular. Further, the uniform density is not limited to the density of the patch on the printing medium that is printed and output and may indicate a uniform density in the print data for generating the patch.

At S704, the scanned data of the printed and output HS chart is obtained. Specifically, the HS chart for which the print processing has been performed by the printing unit 107 is read by the line sensor 208 configuring the scanning unit 108 and the scanned data of the HS chart is generated.

At S705, based on the scanned data obtained at S704, a line profile corresponding to the line sensor 208 is generated. Specifically, the measurement area (patch) of the HS chart is identified from the scanned data and one-dimensional data (line profile) is found, which is obtained by averaging the sensor values in the conveyance direction (y-direction). The line profile is obtained by averaging each read value at the different y-position at an identical x-position in each measurement area. In a case where the HS chart 800 shown in FIG. 8 described previously is used, nine line profiles corresponding to the measurement areas 801 to 809 are obtained.

At S706, for each line profile obtained at S705, sensor shading correction processing based on the pixel position in the x-direction is performed by using a scan correction table that can be used. Here, a case is considered where the sensor value at the pixel position x=50 of the line profile corresponding to the measurement area 808 of the HS chart 800 shown in FIG. 8 is “24” and the sensor shading correction processing is performed by using the scan correction table shown in FIG. 5. In this case, first, the SS correction values for the sensor value “24” at the pixel positions x=0, 100 are found by the interpolation calculation. Specifically, for the pixel position x=0, from the SS correction values “29” and “40” corresponding to the sensor values “16” and “32”, 29+ (40−29)×(24-16)÷(32-16)=34.5 is obtained as the SS correction value. Similarly, for the pixel position x=100, 32.0 is obtained as the SS correction value. Then, from the two calculated SS correction values “34.5” and “32.0”, 32.0+(34.5−32.0)×(100−50)÷(100−0)=33.25 is obtained as the SS correction value for the pixel position x=50. As described above, by finding the SS correction value at each pixel position in the x-direction based on the scan correction table for each line profile, the line profile for which the sensor shading correction processing has been performed is obtained.

At S707, the pixel position and the nozzle number in the scanned data are caused to correspond to each other. Specifically, from the scanned data, the position adjustment patterns 810a to 810j are detected and processing to cause each position of the marker configuring each pattern and the number of the nozzle for which the marker has been formed to correspond to each other is performed.

At S708, the nozzle number (nozzle of interest id) of the nozzle of interest among all the nozzles arrayed in the x-direction is initialized. In the present embodiment, the nozzle at the left end of the print head is set as the nozzle of interest id=0.

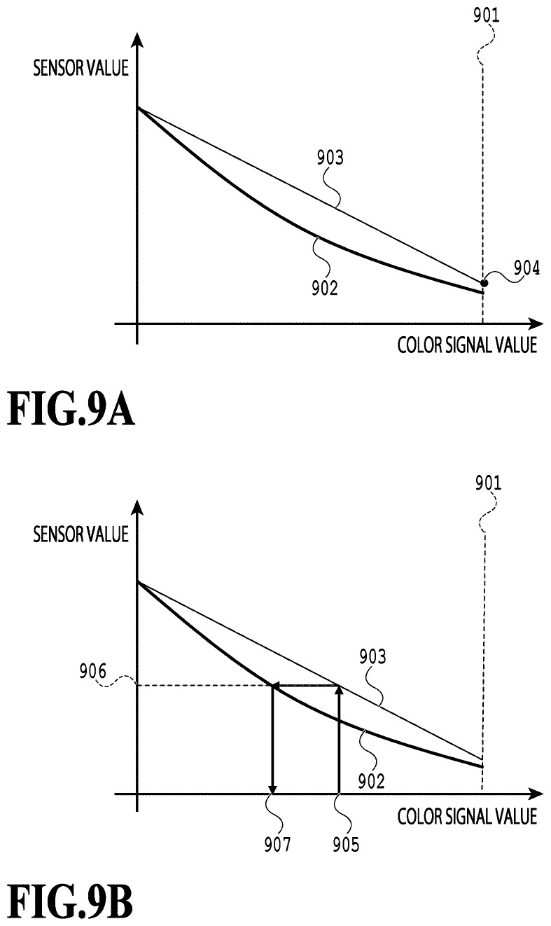

At S709, the correction amount for the current nozzle of interest id is calculated and the adjusted color signal value for the nozzle of interest is determined. Specific explanation is given by using the drawings. First, for the generation of the color adjustment table, a measured curve corresponding to the nozzle of interest is calculated. Here, the measured curve is a curve indicating a relationship between the color signal value of the target measurement area and the sensor value at the pixel position corresponding to the nozzle of interest on each line profile. FIG. 9A shows an example of the measured curve. The horizontal axis in FIG. 9A represents the color signal value of an image that is formed on a sheet by the printing unit 107 and the vertical axis represents the sensor value that is obtained by the scanning unit 108 scanning the sheet. A broken line 901 in FIG. 9A indicates the upper limit value of the horizontal axis and in a case where the input color signal value is an 8-bit value, the upper limit value is “255”. A curve 902 in FIG. 9A is a measured curve obtained by combining the color signal value of the measurement area included in the HS chart and the sensor value corresponding to each tone, and further combining the interpolation calculation. As the interpolation method, it may be possible to use a publicly known method, such as the piecewise linear interpolation and the spline curve. The measured curve 902 represents the density characteristics of the nozzle corresponding to the pixel position in the x-direction of the scanned data and for example, for the nozzle whose ejection amount is small, the curve shifts in the upward direction (toward the direction in which brightness becomes high). A straight line 903 in FIG. 9A indicates the ejection characteristics (target ejection characteristics) common to all the nozzles, which are the correction target of each nozzle. It may be possible to set the target ejection characteristics by, for example, finding each value that is linear to a sensor value 904 corresponding to the maximum color signal value determined in advance. Alternatively, it may also be possible to take the head module, the chip module, or the nozzle to be a reference and set the ejection characteristics of the reference module or nozzle as the target ejection characteristics. Alternatively, it may also be possible to set the ejection characteristics obtained by averaging the ejection characteristics of the head modules, the chip modules, or the nozzles in a predetermined range as the target ejection characteristics. FIG. 9B is a diagram explaining the calculation of the correction amount. First, the nozzle of interest id and an input color signal value 905 that is taken to be the target of the correction amount calculation are obtained. Next, a target value 906 corresponding to the obtained input color signal value 905 is obtained from the target ejection characteristics 903 of the nozzle of interest. Further, from the measured curve 902 of the nozzle of interest, the tonal value corresponding to the target value 906 is obtained as an adjusted color signal value 907. Then, the obtained adjusted color signal value 907 and the input color signal value 905 are caused to correspond to each other and stored in the color adjustment table being generated in association with the nozzle of interest. By performing the processing such as this with all the values of 0 to 255 being taken as the input color signal value 905, it is possible to obtain a table corresponding to all the tonal values for the nozzle of interest. Alternatively, it may also be possible to generate a table corresponding to, for example, nine specific tonal values, by thinning the tonal values. In that case, it may be possible to find the value other than the specific tonal values from the nine specific tonal values by the publicly known interpolation processing.

At S710, whether the correction amount calculation is completed for all the nozzles is determined. In a case where the nozzle of interest id is larger than or equal to the number of nozzles comprised by the print heads 201 to 204, it is determined that the correction amount calculation is completed. In a case where there is an unprocessed nozzle, the processing advances to S711 and the nozzle of interest id is updated, and the processing returns to S708 and the same processing is repeated. On the other hand, in a case where it is determined that the correction amount calculation is completed already by taking all the nozzles as the nozzle of interest, the processing advances to S712.

At S712, the color adjustment table reflecting the correction amount of each nozzle, which is obtained by the processing up to this point, is stored in the external storage device 105. In this case, the color adjustment table is stored in association with information on the sheet, such as the maker name, the model number, and the sheet type of the used sheet, the printing conditions, such as the print mode, and the date of generation.

The above is the contents of the color adjustment table generation processing. The processing such as this is performed for each ink color (C, M, Y, K) and the color adjustment table corresponding to each of CMYK is generated.

### <Generation Processing of Scan Correction Table>

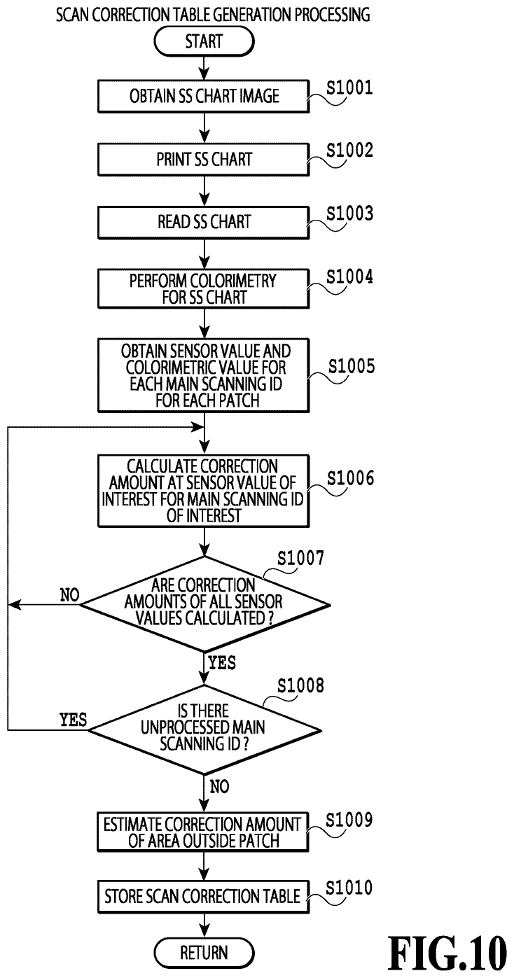

Next, with reference to the flowchart shown in FIG. 10, the generation processing of a scan correction table at S702 described above is explained in detail. This processing is performed for each ink color.

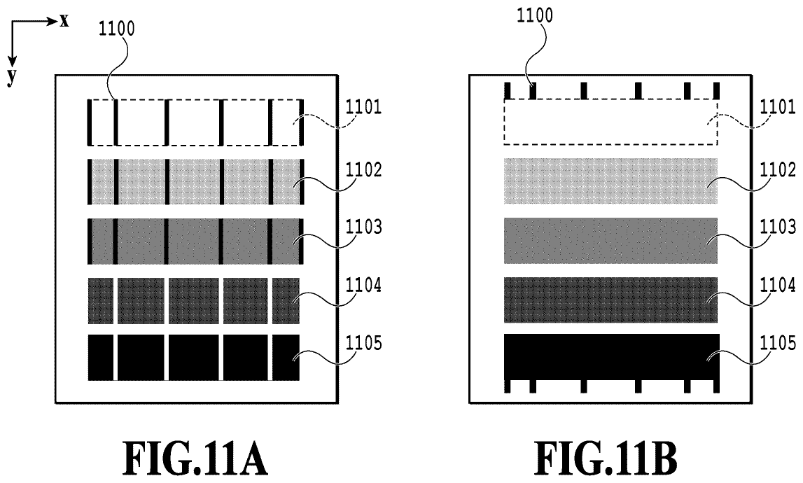

First, at S1001, the data of the SS chart image that is used for print processing at S1002 is obtained. In the present embodiment, the data of the SS chart image is obtained, which is created by taking into consideration the unevenness in the main scanning direction (x-direction) of the print heads 201 to 204 and the scanning unit 108. In each of FIG. 11A and FIG. 11B, one example of the SS chart image of the present embodiment is shown. In each SS chart image in FIG. 11A and FIG. 11B, five patches (measurement areas) 1101 to 1105 whose tones are different from one another exist and each patch extends in the main scanning direction (x-direction) substantially perpendicular to the conveyance direction of a sheet and has a uniform density. Then, on each SS chart image, a plurality of thin lines (markers) 1100 put side by side in the main scanning direction is arranged. Here, in the SS chart image shown in FIG. 11A, inside each of the five patches 1101 to 1105 whose densities are different, the markers 1100 are arranged. Further, in the SS chart image shown in FIG. 11B, at the top portion of the patch 1101 and at the bottom portion of the patch 1105, the markers 1100 are arranged. In each SS chart image, the five areas on the patch, which are obtained by separating the patch at the marker positions in the x-direction, correspond to the main scanning IDs (0 to 4) described previously. That is, the main scanning IDs (0 to 4) described previously indicate five reading positions in the x-direction in the scanned data. Here, in the SS chart image in FIG. 11A, for the low-density patches 1101 to 1103, the markers 1100 are formed in a target ink color and for the high-density patches 1104 and 1105, the markers are formed in solid white (ground color of paper in a case where ink is not ejected). Further, in a case where the markers are arranged inside the patch, it is desirable to form the markers also at both the left end and the right end of the patch for the low-density patches 1101 to 1103. In the present embodiment, the SS chart image in FIG. 11A is created and obtained, but it may also be possible to read and obtain an SS charge image created and stored in advance. The creation method of an SS chart image will be described later.

At S1002, the print processing of the SS chart image obtained at S1001 is performed. Here, the SS chart image in FIG. 11A is subjected to halftone processing in the HT processing unit 305 and converted into a halftone image and print processing is performed by the printing unit 107. In this manner, the printed SS chart is obtained.

At S1003, the SS chart output from the printing unit 107 is read by the line sensor 208. Due to this, the scanned data of the SS chart is generated.

At S1004, the SS chart output from the printing unit 107 is subjected to colorimetry by the colorimeter 209. Due to this, the colorimetric data of the SS chart is generated.

At S1005, based on the scanned data obtained at S1003 and the colorimetric data obtained at S1004, the sensor value and the colorimetric value are obtained for each main scanning ID of each patch in the SS chart. Specifically, first, from the colorimetric data, from each of a plurality of areas (=area corresponding to each main scanning ID) into which the patch is separated by the markers in each patch, an average colorimetric value is obtained. Here, in the SS chart, the five patches 1101 to 1105 whose tones are different exist and in each individual patch, the five areas separated by the markers 1100 exist, and therefore, 5×5=25 average colorimetric values are obtained. Similarly, from the scanned data, from each of the areas (=area corresponding to each main scanning ID) obtained by separating each of the patches 1101 to 1105 at the positions of the markers 1100, 25 average sensor values are obtained.

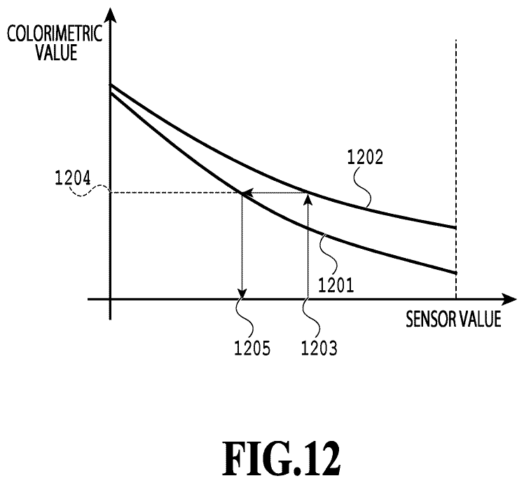

At S1006, for the main scanning ID of interest, the correction amount at the input sensor value of interest is calculated. The way of thinking of the correction amount calculation is the same as that at S709 described previously. FIG. 12 is a diagram explaining the calculation of the correction amount at this step and the horizontal axis represents the sensor value and the vertical axis represents the colorimetric value. In FIG. 12, 1201 indicates a measured curve and this is obtained by interpolation calculation based on the sensor value and the colorimetric value of each of the patches 1101 to 1105. The measured curve 1201 indicates a correspondence relationship between the sensor value and the colorimetric value in the area corresponding to the main scanning ID of interest and in a case where there is unevenness in the reading characteristics of the sensor of the scanning unit 108, a different measured curve is obtained for each area corresponding to the main scanning ID. As a target characteristics 1202, what is obtained by averaging the measured curves obtained for each area corresponding to each main scanning ID is taken to be the target characteristics. The determination method of the target characteristics is arbitrary and it may also be possible to use arbitrary values determined in advance. In a case where the correction amount is calculated, an input sensor value 1203 that is taken to be the target of correction amount calculation is obtained. Next, a target value 1204 corresponding to the obtained input sensor value 1203 is obtained from the target characteristics 1202. Further, from the measured curve 1201, the sensor value corresponding to the target value 1204 is obtained as an adjusted sensor value 1205. Then, the obtained adjusted sensor value 1205 and the input sensor value 1203 are associated with each other and stored in the RAM 101 in association with the main scanning ID of interest.

At S1007, whether the calculation of the correction amount is completed for all the sensor values is determined. In a case where there is a sensor value for which the correction value is not calculated yet, the processing returns to S1006 and the calculation of the correction amount for the next sensor value of interest is performed. On the other hand, in a case where the calculation of the correction amount for all the sensor values is completed, the processing advances to S1008.

At S1008, whether the correction amount calculation processing of each sensor value for the areas corresponding to all the main scanning IDs is completed is determined. In a case where there is a main scanning ID for which the processing is not performed yet, the correction amount calculation processing of each sensor value for the area corresponding to the next main scanning ID of interest is performed. On the other hand, in a case where the correction amount calculation processing of each sensor value for the areas corresponding to all the scanning IDs is completed, the processing advances to S1009.

At S1009, the estimation of the correction amount for the area outside patch is performed. Here, the area outside patch refers to the area excluding the patch portion of the readable area of the sensor of the scanning unit 108. In a case where the sheet width is small for the readable area of the sensor, the end portion area of the readable area is the area outside patch. It is possible to estimate the correction amount of the area outside patch by linearly extrapolating the correction amount for the patch obtained as described above.

At S1012, based on the correction amount of each sensor value of each main scanning ID, which is obtained by the processing up to this point, the scan correction table shown in FIG. 5 described previously is generated and stored in the external storage device 105. In this case, the scan correction table is stored in association with the information relating to the sheet, such as the maker name, the model number, and the sheet type of the used sheet, the printing conditions, such as the print mode, and the date of generation.

The above is the contents of the scan correction table generation processing.

### <Creation Method of SS Chart Image>

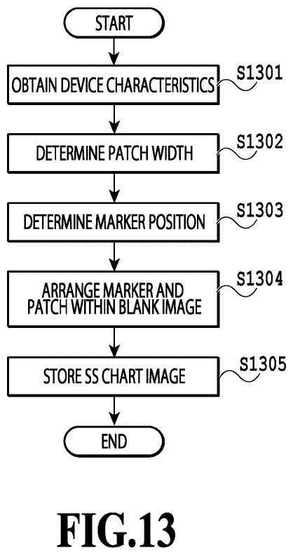

Following the above, the creation method of the SS chart image that is obtained at S1001 described previously is explained. FIG. 13 is a flowchart showing a flow of the creation processing of an SS chart image. In the following, explanation is given along the flowchart in FIG. 13.

At S1301, the device characteristics are obtained. Here, the device characteristics mean information relating to the unevenness in the main scanning direction (x-direction) of the print heads 201 to 204 or the scanning unit 108, which should be taken into consideration in a case where a color adjustment table is generated. In the present embodiment, for a plurality of chip modules configuring the print heads 201 to 204 shown in FIG. 2B, the positional information on both the left end portion and the right end portion of each chip module and on the boundary between the chip modules adjacent to each other is obtained as the device characteristics.

At S1302, the width of each patch that is arranged on the SS chart image is determined based on the sheet width. Here, the length after allowing each of both the left end and the right end a margin of 10 mm for the width of the sheet 206 (that is, the length is a value obtained by subtracting 20 mm from the sheet width) is determined to be the patch width. The margin is not limited to 10 mm.

At S1303, the position in the main scanning direction of each marker that is arranged on the SS chart image is determined based on the device characteristics obtained at S1301 and the patch width determined at S1302. Specifically, the marker position in the main scanning direction is determined to be the position corresponding to each chip module boundary. For example, in a case of the SS chart image in FIG. 11A described previously, the position at which each chip module boundary intersects the patch in a case where it is extended in the sub scanning direction (y-direction) is taken to be the marker position in the main scanning direction. Further, the positions of both the left end and the right end in the patch whose density is low are also determined to be the maker position. Furthermore, in a case of the SS chart image in FIG. 11B described previously, both the left end and the right end of the patch in the margin areas at the top portion and the bottom portion at which the patch does not exist and the position corresponding to each chip module are taken to be the marker positions in the main scanning direction.

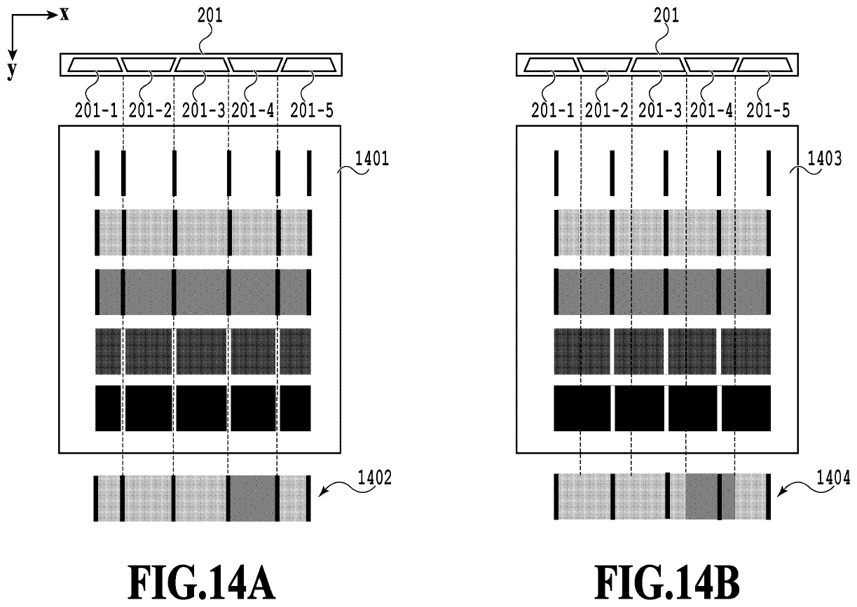

At S1304, the SS chart image is created by arranging the patches and the markers within a blank image based on the patch width determined at S1302 and the marker positions determined at S1303. In the example of the SS chart image in FIG. 11A and FIG. 11B described previously, the patches are arranged side by side in order from the patch whose density is the lowest, but it may also be possible to arrange the patches in order form the patch whose density is the highest. An SS chart image 1401 in FIG. 14A is the same as the SS chart image in FIG. 11A described previously. As shown in FIG. 14A, it can be seen that the marker is arranged at the position corresponding to each chip module boundary (each boundary between 201-1 and 201-2, 201-2 and 201-3, 201-3 and 201-4, and 201-4 and 201-5).

Next, at S1305, the data of the SS chart image created at S1304 is stored in the external storage device 105.

In this manner, it is possible to obtain the SS chart image that takes into consideration the boundary positions of the chip modules configurating the print heads 201-204.

### <Effects by SS Chart of the Present Embodiment>

Here, it is assumed that the ink ejection amount of the second chip module 201-4 from the right among the five chip modules 201-1 to 2015 configuring the print head 201 is relatively large. In this case, in the SS chart that is obtained by printing the SS charge image 1401 in FIG. 14A described above, the density of the portion corresponding to the chip module 201-4 is high compared to that of the portions other than that portion. In FIG. 14A, a symbol 1402 indicates the patch portion of the second tone in the printed SS chart and among the five areas separated by the markers, the density of only the second area from the right is relatively high. That is, in a case of the SS chart of the present embodiment, the density is substantially uniform within each area separated by the markers. FIG. 14B shows an SS chart for comparison, which is obtained by printing a conventional SS chart image 1403 on which markers are arranged at uniform intervals on each patch under the same conditions. In FIG. 14B, a symbol 1404 indicates the patch portion of the second tone in the conventional SS chart that is printed. Similarly as above, the density of the portion corresponding to the chip module 201-4 is high compared to that of the portions other than that portion, but the portion whose density is high spreads across a plurality of areas separated by the markers. That is, in a case of the conventional SS chart, a step in density resulting from the chip module boundary occurs within the first and second areas from the right.

Here, for each area separated by the markers on the printed SS chart, the scanning unit 108 obtains the average value of the sensor values and the colorimetry unit 110 obtains the average value of the colorimetric values, respectively. In this case, on a condition that a step in density occurs within the area separated by the markers as in the conventional SS chart, it is not possible to stably obtain the average value of the sensor values and the average value of the colorimetric values. In particular, in a case of colorimetry, a sufficient opening diameter is necessary generally, and therefore, it is difficult to avoid this influence. In contrast to this, in the SS chart of the present embodiment, the marker position in the main scanning direction is caused to coincide with the chip module boundary of the print head. Due to this, it is possible to suppress the unevenness in density within the area separated by the markers, and therefore, it is possible to stably obtain the sensor value and the colorimetric value.

### Modification Example 1

In the above-described embodiment, the SS chart is used in common for scan and for colorimetry, but this is not limited. For example, it may also be possible to use an SS chart image that is different for different uses, such as that the SS chart image in FIG. 11A is used for colorimetry and the SS chart image in FIG. 11B is used for scan. Further, the marker positions in the main scanning direction (x-direction) in this case may be made completely the same between those for colorimetry and those for scan, or may be different. However, in a case where the marker positions are made different, it is also necessary to maintain the correspondence of the marker positions between both images. In general, it is possible for the scanning unit 108 to obtain data whose resolution is higher than that of the colorimetry unit 110. Because of this, in the SS chart image for scan, it is useful to arrange the markers more densely than in the case of the SS chart image for colorimetry.

### Modification Example 2

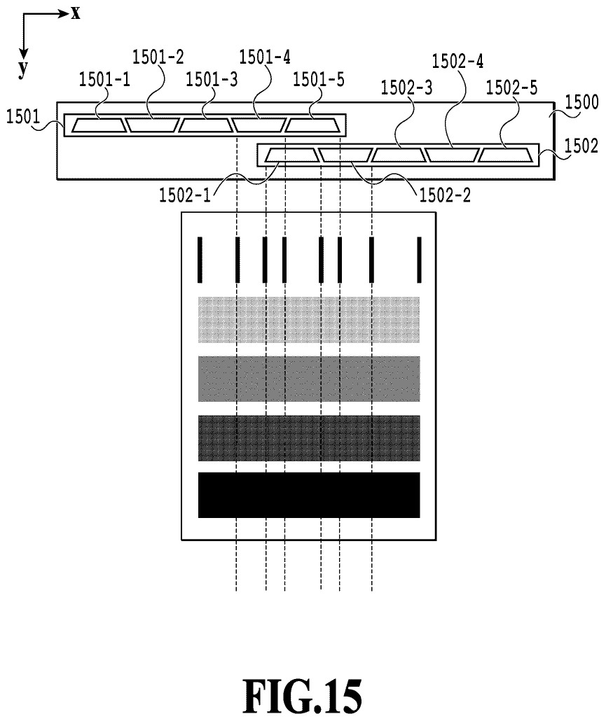

Further, in the above-described embodiment, explanation is given by taking the case as an example where each of the print heads 201 to 204 includes a plurality of chip modules, but the case is not limited to this. For example, it is also possible to apply the present embodiment to a print head (so-called linked head) having a configuration in which a plurality of head modules (each individual head module includes a plurality of chip modules) whose length is less than the sheet width is linked together. FIG. 15 is a diagram explaining the present modification example and a print head 1500 includes two head modules 1501 and 1502. Then, the head module 1501 has a plurality of chip modules 1501-1 to 1501-5 and the head module 1502 also has a plurality of chip modules 1502-1 to 1502-5. In this case, as shown in FIG. 15, it is sufficient to determine the chip module boundary in each head module to be the marker position. At this time, in a case where the two adjacent marker positions are too close (in a case where the distance is less than or equal to a threshold value), it may also be possible to integrate the two marker positions into one marker position.

As above, according to the present embodiment, by aligning the marker position on the SS chart image with the boundary of the chip module configuring the print head, it is possible to stably obtain the sensor value and the colorimetric value. As a result of that, it is possible to correct the reading characteristics of the sensor with high accuracy based on the colorimetric data.

### Second Embodiment

In the first embodiment, the position in the main scanning direction of the marker that is arranged on the SS chart image is determined in accordance with the boundary of the chip module configuring the print head. Next, an aspect is explained as a second embodiment in which the width of a patch that is arranged on the SS chart image is adjusted in accordance with the position of the end portion of the chip module configuring the print head. Explanation of the contents common to those of the first embodiment is omitted and in the following, the creation method of an SS chart image is explained mainly, which is a different point.

### <Creation Method of SS Chart Image>

A rough flow of the creation processing of an SS chart image is common to that of the first embodiment, and therefore, in the following, explanation is given along the flowchart in FIG. 13 used in the first embodiment.

First, at S1301, the device characteristics are obtained. The device characteristics here are the same as those of the first embodiment and for the plurality of chip modules configuring the print heads 201 to 204 shown in FIG. 2B, the positional information on both the left end and the right end of the chip module and the boundary between the chip modules adjacent to each other is obtained.

At next S1302, the width of each patch that is arranged on the SS chart image is determined based on the positions of the leftmost end and the rightmost end of the chip module. Specifically, the patch width is determined so that the left end position of the chip module located on the leftmost side and the left end position of the patch coincide with each other and the right end position of the chip module located on the rightmost side and the right end position of the patch coincide with each other.

At next S1303, the position in the main scanning direction (x-direction) of each marker that is arranged on the SS chart image is determined based on the device characteristics obtained at S1301 and the patch width determined at S1302. In a case of the present embodiment, the positions of both the left end and the right end in the patch width determined at S1302 and the position corresponding to the chip module boundary are determined to be the marker positions. As a result of that, the interval of the markers that are arranged becomes uniform and the size of each area on the patch also becomes uniform, which is obtained by separating the patch at the marker positions.

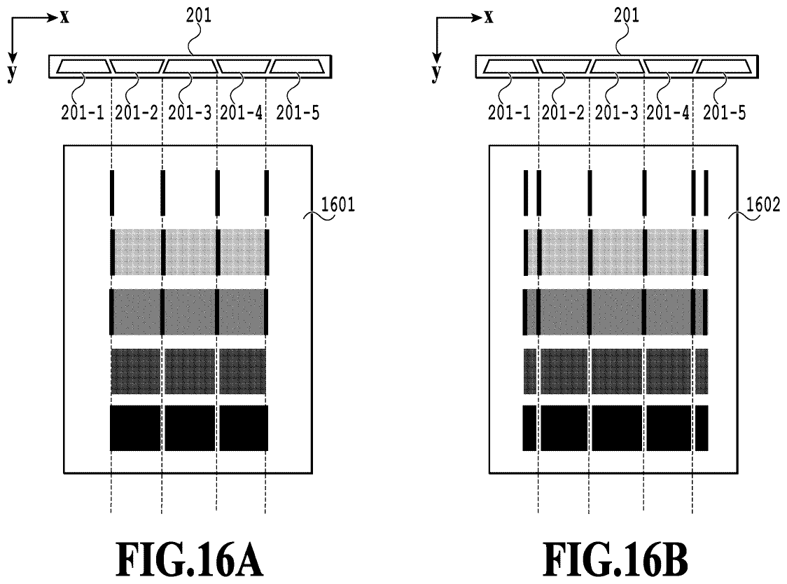

At S1304 that follows, an SS chart image is created by arranging the patches and markers within a blank image based on the patch width determined at S1302 and the marker positions determined at S1303. FIG. 16A shows an SS chart image 1601 in a case where the patch width is determined based on the device characteristics according to the present embodiment. FIG. 16B is a comparative example and shows an SS chart image 1602 in a case where the width after a margin of 10 mm is provided on the left and right sides to the sheet width is taken to be the patch width. In the SS chart image 1601 of the present embodiment, as described above, the interval of all the markers that are arranged becomes uniform and all the sizes of the areas on the patch are also uniform, which are obtained by separating the patch at the marker positions. In contrast to this, in a case of the SS chart image 1602 in FIG. 16B, the size of the area in a case where the patch is separated at the marker positions is small at the patch end portion. As described above, in a case where the size of the area that is taken to be the target of reading or colorimetry is small only at both end portions, there is a concern that the accuracy of the colorimetric value and the sensor value that are obtained from the area deteriorates compared to that obtained from the area at the patch center. In FIG. 16B, for convenience of explanation, an extreme example is shown, but depending on the relationship among the sheet width, the amount of margin, the position of the chip module boundary and the like, such a concern will surface.

Then, at S1305, the data of the SS chart image created at S1304 is stored in the external storage device 105.

### Modification Example

In the above-described embodiment, the patch width is determined so that the positions of both the left end and the right end of the chip module configuring the print head and the positions of both the left end and the right end of the patch coincide with each other at all times, but it may also be possible to determine the above-described patch width only in a case where a condition is satisfied. For example, first, the value obtained by subtracting 20 mm corresponding to the left and right margins from the sheet width is taken to be a provisional patch width and the positions of both the left end and the right end of the patch, which are determined based on the determined provisional patch width, and the positions of both the left end and the right end of the chip module configuring the print head are compared. Then, threshold value processing based on the comparison results is performed and only in a case where both the positions are too close, the patch width may be determined by modifying the provisional patch width so that the positions of both the left end and the right end of the patch and the positions of both the left end and the right end of the chip module coincide with each other.

As above, according to the present embodiment, by determining the patch width and the marker positions in accordance with the boundary positions of the chip module configuring the print head, it is possible to further suppress the deterioration of the correction accuracy.

### Third Embodiment

In the first and second embodiments, the aspect is such that the marker positions to be arranged on the SS chart image are determined in accordance with the characteristics of the print head. Next, an aspect is explained as a third embodiment in which the marker positions to be arranged on the SS chart are determined in accordance with the characteristics of the scanning unit. Explanation of the contents common to those of the first and second embodiments is omitted and in the following, the creation method of an SS chart image is explained mainly, which is a different point.

### <Creation Method of SS Chart Image>

A rough flow of the creation processing of an SS chart image is common to that of the first embodiment, and therefore, in the following, explanation is given along the flowchart in FIG. 13 used in the first embodiment.

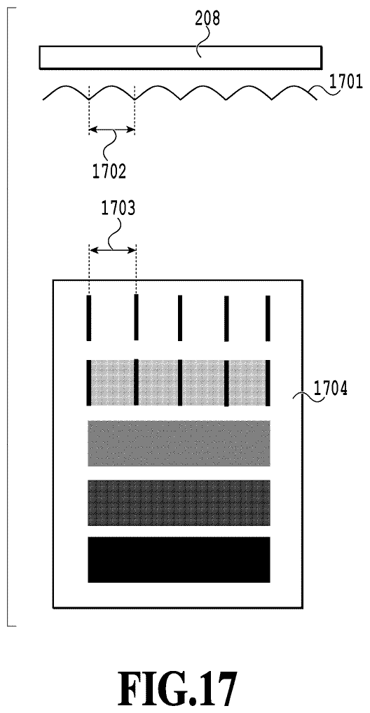

At S1301, the device characteristics are obtained. In the present embodiment, information indicating the trend of variations of the sensor value at each reading position of the line sensor 208 (in the following, called “reading characteristic information”) is obtained as the device characteristics. FIG. 17 shows one example of the reading characteristic information on the line sensor 208 that covers the entire surface of the sheet 206. In FIG. 17, a wavy line 1701 schematically shows variations of brightness at each reading position in the main scanning direction (x-direction) and means that the sensor value is a value corresponding to relatively high brightness at the high position of the waveform and that the sensor value is a value corresponding to relatively low brightness at the low position of the waveform. Further, in FIG. 17, a two-directional arrow 1702 indicates the period of the waveform. There is a case where the periodic unevenness in brightness such as this (variations of brightness in the main scanning direction) occurs due to the arrangement of illumination comprised by the scanning unit 108 and what is prepared in advance as the reading characteristic information on the line sensor 208 is read and obtained from the external storage device 105 and the like.

At S1302, the width of each patch that is arranged on the SS chart image is determined based on the reading characteristic information obtained at S1301. Here, the patch width is determined so that the patch width is N (N is a natural number) times the period of the unevenness in brightness indicated by the obtained reading characteristic information. In the example in FIG. 17, N=4. In a case of a patch having this patch width, the positions of both the left end and the right end thereof coincide with the positions of both the left end and the right end of the chip module configuring the print heads 201 to 204.

At S1303, the position in the main scanning direction (x-direction) of each marker that is arranged on the SS chart image is determined based on the device characteristics obtained at S1301 and the patch width determined at S1302. In a case of the example in FIG. 17, the positions of both the left end and the right end in the patch width determined at S1302 and the positions at which the patch width is uniformly divided into N portions are determined to be the marker positions.

At S1304, an SS chart image is created by arranging patches and markers within a blank image based on the patch width determined at S1302 and the marker positions determined at S1303. In a case of the example in FIG. 17, an SS chart image 1704 in which markers area arranged at uniform intervals in accordance with the period of the unevenness in brightness is obtained.

At S1305, the data of the SS chart image created at S1304 is stored in the external storage device 105.

In this manner, it is possible to obtain the SS chart image that takes into consideration the periodic unevenness in brightness of the line sensor 208 configuring the scanning unit 108. In a case where the period of the unevenness in brightness of the scanning unit 108 and the marker interval do not coincide with each other, the sensor value changes in accordance with a shift of phase, and therefore, a reading error occurs. In a case of the present embodiment, by causing the period of the unevenness in brightness of the line sensor 208 and the marker interval to coincide with each other, it is possible to suppress a reading error of the sensor value from occurring.

### Modification Example 1

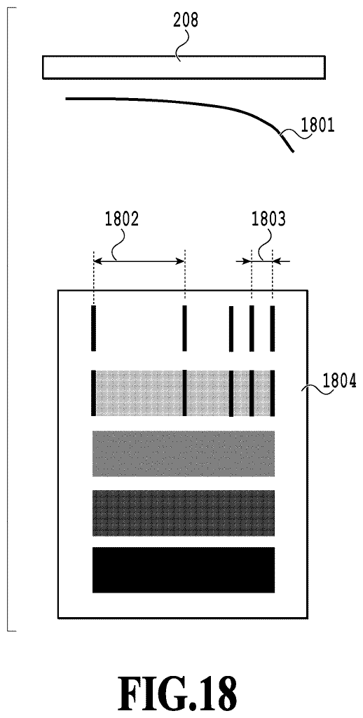

In the above-described embodiment, the position in the main scanning direction (x-direction) of each marker is determined in accordance with the period of the unevenness in brightness of the line sensor 208, but this is not limited. For example, it may also be possible to determine the arrangement density of the markers in the main scanning direction in accordance with the degree of the variations of the brightness of the line sensor 208. FIG. 18 shows one example of brightness information on each reading position of the line sensor 208 covering the full width of the sheet 206. In FIG. 18, a curve 1801 schematically shows the variations of brightness at each reading position in the main scanning direction (x-direction). Here, the curve 1801 indicates that the sensor value corresponding to relatively high brightness continues and variations are small on the left side, but on the right side, as the end is approached, the sensor value becomes a value corresponding to low brightness and variations become large. In this case, at the portion at which the variations are small, the marker positions are determined so that the interval between markers is wide and at the portion at which the variations are large, the marker positions are determined so that the interval between markers is narrow. In a case where the line sensor 208 has the characteristic represented by the curve 1801, an SS chart image 1804 in which markers are arranged at the interval in accordance with the degree of change in brightness is obtained. By arranging markers densely at the portion at which the degree of change in brightness is high within the reading range of the line sensor 208, it is possible to make small the error in a case where the sensor values are averaged for each area separated by markers.

### Modification Example 2

In the above-described embodiment, the reading characteristic information created and held in advance is obtained as the device characteristics, but it may also be possible to create and obtain the device characteristics dynamically. As the creation method, it is sufficient to print the chart (for example, HS chart shown in FIG. 6) having patches whose density is uniform in the main scanning direction, obtain scanned data by reading the chart, and analyze the unevenness period within the patch at timing at which it is determined that the generation of a scan correction table is necessary (NO at S701). For the analysis of the period, it is possible to apply a publicly known method, such as correlation and Fourier transformation.

As above, according to the present embodiment, the positions of markers to be arranged on an SS charge image are determined by taking into consideration the brightness unevenness of the line sensor. Due to this, it is possible to suppress deterioration of correction accuracy.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to correct reading characteristics of a sensor configuring a scanner with high accuracy based on colorimetric data.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-190638 filed Nov. 8, 2023 which is hereby incorporated by reference wherein in its entirety.

What is claimed is:

1. An image processing apparatus comprising:
a printing unit configured to print a chart image including a patch extending in a main scanning direction intersecting a conveyance direction of a sheet and having a uniform density and a marker for identifying a position in the main scanning direction;
a scanning unit configured to read the chart image printed by the printing unit; and
a correction unit configured to correct reading characteristics of the scanning unit based on reading results read by the scanning unit, wherein
the marker is arranged in the main scanning direction based on information relating to unevenness in the main scanning direction of the printing unit or the scanning unit.

2. The image processing apparatus according to claim 1, wherein
the printing unit has a print head ejecting ink,
the printing unit has a generation unit configured to generate the chart image, and
the generation unit:
obtains positional information on a chip module boundary of a plurality of chip modules configuring the print head as information relating to unevenness in the main scanning direction of the printing unit; and
determines each position corresponding to a chip module boundary as a marker position in the main scanning direction based on the obtained positional information.

3. The image processing apparatus according to claim 2, wherein
the generation unit:
determines a patch width based on a width of the sheet; and
further determines positions corresponding to both a left end and a right end of a patch with a determined patch width as a marker position in the main scanning direction.

4. The image processing apparatus according to claim 3, wherein
on the chart image, a plurality of patches whose densities are different is arranged and
the generation unit further determines positions corresponding to both a left end and a right end of a patch with a determined patch width as a marker position in the main scanning direction only for patches whose densities are relatively low among the plurality of patches.

5. The image processing apparatus according to claim 2, wherein
the generation unit:
determines, based on a width of the sheet, a patch width so that the left end position of a chip module located on the leftmost side among a plurality of chip modules configuring the print head and the left end position of the patch coincide with each other and the right end position of a chip module located on the rightmost side and the right end position of the patch coincide with each other; and
determines, based on the obtained positional information, each position in the patch, which corresponds to a chip module boundary in the plurality of chip modules, as a marker position in the main scanning direction.

6. The image processing apparatus according to claim 5, wherein
the generation unit determines a patch width so that the left end position of the patch with the determined patch width and the left end position of the chip module located on the leftmost side coincide with each other and the right end position of the patch with the determined patch width and the right end position of the chip module located on the rightmost side coincide with each other.

7. The image processing apparatus according to claim 5, wherein
the generation unit:
determines a provisional patch width based on a width of the sheet;
finds a distance between the left end position of the patch with the determined provisional patch width and the left end position of the chip module located on the leftmost side and a distance between the right end position of the patch with the determined provisional patch width and the right end position of the chip module located on the rightmost side; and
determines, in a case where the found distance is less than a threshold value, a patch width so that the left end position of the patch with the determined patch width and the left end position of the chip module located on the leftmost side coincide with each other and the right end position of the patch with the determined patch width and the right end position of the chip module located on the rightmost side coincide with each other.

8. The image processing apparatus according to claim 5, wherein
the generation unit generates a chart image so that the size of each area on a patch becomes uniform, which is obtained by separating the patch at determined marker positions.

9. The image processing apparatus according to claim 1, wherein
the scanning unit has a line sensor covering the full width of the sheet,
the printing unit has a generation unit configured to generate the chart image, and the generation unit:
obtains reading characteristic information indicating a trend of variations of a sensor value at each reading position in the line sensor as information relating to unevenness in the main scanning direction of the scanning unit; and
determines marker positions in the main scanning direction so that a period of unevenness in brightness of the line sensor and an interval between markers in the main scanning direction coincide with each other based on the obtained reading characteristic information.

10. The image processing apparatus according to claim 9, wherein
the generation unit:
determines a patch width based on the obtained reading characteristic information; and
determines each position at which the determined patch width is divided uniformly into N portions as a marker position in the main scanning direction.

11. The image processing apparatus according to claim 1, wherein
the scanning unit has a line sensor covering the full width of the sheet,
the printing unit has a generation unit configured to generate the chart image, and
the generation unit:
obtains reading characteristic information indicating a trend of variations of a sensor value at each reading position in the line sensor as information relating to unevenness in the main scanning direction of the scanning unit; and
determines marker positions, based on the obtained reading characteristic information, so that arrangement density of markers in the main scanning direction at a portion corresponding to a reading position at which variations of brightness of the line sensor are relatively large is higher than arrangement density of markers in the main scanning direction at a portion corresponding to a reading position at which variations of brightness of the line sensor are relatively small.

12. The image processing apparatus according to claim 9, wherein
the generation unit determines marker positions by obtaining the reading characteristic information prepared in advance.

13. The image processing apparatus according to claim 9, further comprising:
a unit configured to create the reading characteristic information, wherein
the generation unit determines marker positions by obtaining the created reading characteristic information.

14. A control method of an image processing apparatus, wherein
the image processing apparatus comprises:
a printing unit configured to print a chart image including a patch extending in a main scanning direction intersecting a conveyance direction of a sheet and having a uniform density and a marker for identifying a position in the main scanning direction; and
a scanning unit configured to read the chart image printed by the printing unit,
the marker is arranged in the main scanning direction based on information relating to unevenness in the main scanning direction of the printing unit or the scanning unit, and
control is performed so as to correct reading characteristics of the scanning unit based on reading results read by the scanning unit.

15. A non-transitory computer readable storage medium storing a program for causing a computer to perform a control method of an image processing apparatus, wherein
the image processing apparatus comprises:
a printing unit configured to print a chart image including a patch extending in a main scanning direction intersecting a conveyance direction of a sheet and having a uniform density and a marker for identifying a position in the main scanning direction; and
a scanning unit configured to read the chart image printed by the printing unit,
the marker is arranged in the main scanning direction based on information relating to unevenness in the main scanning direction of the printing unit or the scanning unit, and
control is performed so as to correct reading characteristics of the scanning unit based on reading results read by the scanning unit.
